(19) United States
(12) Patent Application Publication
(10) Pub. No.: US 2019/0156425 A1
(43) Pub. Date: May 23, 2019

(54) Collateral Mechanisms Using High Quality Redeemable Notes

(71) Applicant: Derrell J. Hendrix, Brookline, MA (US)

(72) Inventor: Derrell J. Hendrix, Brookline, MA (US)

(73) Assignee: RISConsulting Group LLC, The, Boston, MA (US)

(21) Appl. No.: 16/193,272

(22) Filed: Nov. 16, 2018

Related U.S. Application Data
(60) Provisional application No. 62/588,451, filed on Nov. 20, 2017.

(51) Int. Cl. G06Q 40/08; G06Q 40/06; G06Q 50/26

(52) U.S. Cl. CPC G06Q 40/08; G06Q 50/26; G06Q 40/06

(57) ABSTRACT

Techniques for providing collateral and satisfying collateral requirements involve computer-implemented methods including recording, by one or more computers, receipt of proceeds obtained from a first party and placed in a first reference series account in a legal trust for the first party, acquiring by a first entity a high quality liquid asset portfolio according to a specified set of investment criteria for deposit in the first reference series account; and issuing high-quality, redeemable securities backed by the acquired high quality liquid asset portfolio to the first entity. The techniques also include receiving by a second, related entity the high-quality, redeemable securities with the second, related entity seeking collateral for re-insurance; and using by the second, related entity, the high-quality, redeemable securities for, e.g., collateral, for derivatives collateral, for reinsurance collateral, for funds at insurance markets such as Funds at Lloyds and for Canadian RSAs or as an investment asset.

### CLAIM OF PRIORITY

This application claims priority under 35 U.S.C. § 119(e) to provisional U.S. Patent Application 62/588,451, filed on Nov. 20, 2017, entitled: “Collateral Mechanisms Using High Quality Redeemable Notes,” the entire contents of which are hereby incorporated by reference.

### BACKGROUND

This disclosure relates to mechanisms for providing collateral and satisfying collateral requirements under various governmental regulations and business requirements and to investment assets.

Financial institutions and related entities are typically regulated by governmental agencies to ensure that, among other things, the institutions and entities have sufficient capital, as well as sufficient collateral resources to support their investment activities. For example, certain types of United States (U.S. or foreign) insurance companies and reinsurance companies are required by the U.S. state insurance regulations to post a required amount of qualifying collateral in order to underwrite policies to their clients.

Large buyers of insurance and reinsurance policies may require that their insurance and reinsurance providers to be credit-enhanced to alleviate risk-based capital charges, comply with state insurance regulations, and/or individual insurance company and/or reinsurance company credit concentrations. Examples of collateral mechanisms for providing collateral and satisfying collateral requirements is also disclosed in my Issued U.S. Pat. No. 7,769,655 the contents of which are incorporated herein by reference in their entirety.

### SUMMARY

According to an aspect, a computer-implemented method includes recording, by one or more computers, receipt of proceeds obtained from a first party and placed in a first reference series account in a legal trust for the first party, acquiring a high quality liquid asset portfolio according to a specified set of investment criteria for deposit in the first reference series account, transferring the high quality liquid asset portfolio to a segregated money center bank account at a sovereign central bank that are entered on the books and records of money center bank as backing a high-quality, redeemable security, and issuing the high-quality, redeemable security to the investor backed by the acquired high quality liquid asset portfolio.

Aspects also include methods, computer program products, and networked computer systems.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an arrangement for issuing and managing transactions among entity computer systems for producing asset backed securities issued by a trust.

FIG. 2 is a table that depicts note alternatives.

FIGS. 3A and 3B are flowcharts creation and redemption of KT-notes.

FIGS. 4 and 5 are tables depicting comparative benefits.

FIG. 6 is a table depict uses of securitized, collateralized obligations (KT-notes).

FIG. 7 is a diagram that depicts structures of client access to series accounts.

FIG. 8 is a block diagram of an exemplary computer system.

### DETAILED DESCRIPTION

The demand for entities to obtain collateral to provide statutory surplus relief and credit enhancement is growing rapidly. That is, demand in financial markets for collateral has increased because the needs for collateral have spread to additional counterparties involved in financial transactions. For example, the Dodd-Frank legislation in the United States and the global regulatory standard Basel III are expected to significantly expand the market requirements for posting collateral. Regulatory requirements to raise capital that business entities are required to satisfy include collateral requirements for underwriting insurance or reinsurance policies or engaging in other financial market activities, such as purchasing or selling of derivative securities (derivatives), i.e., a contractual instrument that derives its value from the performance of an underlying financial instrument. Such insurance companies require the collateral either for credit requirements and/or regulatory requirements. Examples of business needs include credit enhancement for potential payment obligations. Ideally, a platform 10 as discussed below is structured to satisfy applicable regulatory requirements such as Basel III and Dodd-Frank.

The collateral mechanisms discussed below that generate so called KT-notes (or securitized, collateralized obligations) can also be used for investment purposes as they may have returns comparable to those of other debt type instruments of comparable risk and term.

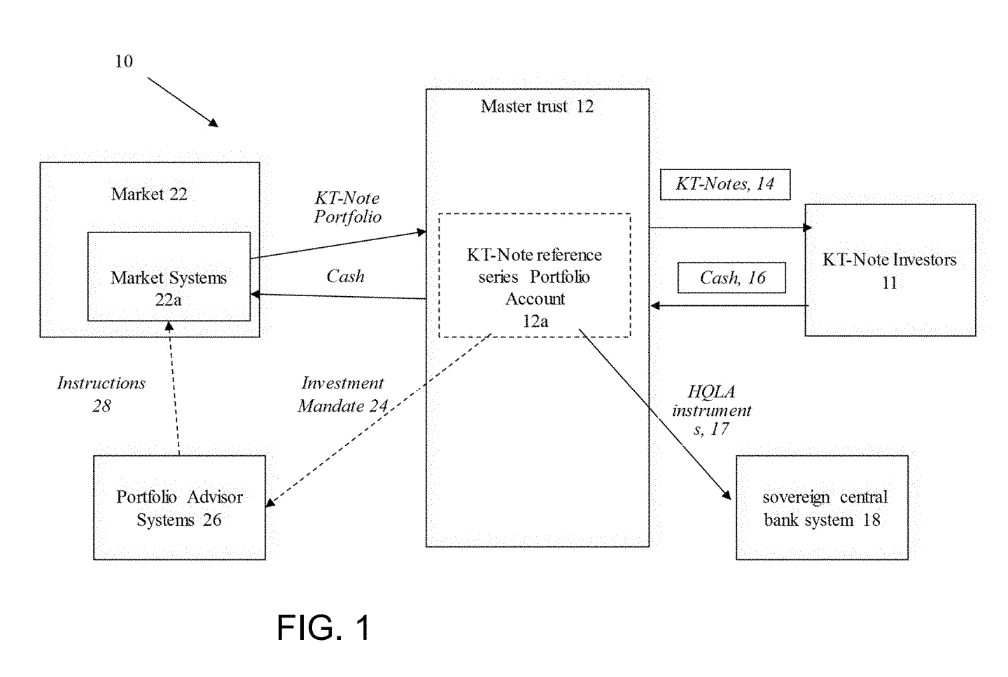

Referring to FIG. 1, platform 10 to provide collateral mechanisms to business entities that need collateral (to satisfy regulatory requirements and/or non-regulatory business needs) for trading is shown. The mechanism includes acquiring by investors 11 from a master trust (or a master trust affiliate(s)) 12 high-quality, redeemable notes (herein also referred to as “KT-Notes”) 14 in exchange for cash 16 of equivalent value from the investors 11. The KT-Notes are backed by securities issued or guaranteed by a sovereign or sovereign governmental agency, e.g., a treasury department of a sovereign, e.g., The United States Treasury, or an agency. The securities are held in an account with a sovereign central bank system 18 such as a CSD (Central Securities Depository subject to special regulation to protect securities. If US Federal securities, the securities are held at the Federal Reserve that in effect functions as a CSD. If European, the securities might be in held at Euroclear (https://en.wikipedia.org/wiki/Central_securities_depository). Here an account at the Federal Reserve (or a like agency) will be used in the description. The instruments 17 that are acquired by the Master Trust 12 are of high quality and are liquid assets, herein referred to as “HQLA” instruments (high quality, liquid asset instruments). The cash 16 received by the master trust 12 is transferred to market systems 22a to procure the HQLA instruments from a debt market 22.

The collateral backing the KT-Note resides in the reference series account of an investor under the investment management of the portfolio advisor 26, but under the operating control of a bank, such as a money center bank that conducts transactions directly with the sovereign central bank. In other embodiments, a single account could be used. The collateral are held at the Federal Reserve but separated on the books and records of the bank (e.g., BNY/Mellon), the master trust's custodian, as belonging to the KT-Note. This effectively segregates the securities from those of both the Portfolio Advisor and custodian, thus eliminating counterparty credit risk.

The trust 12 thus has assets (HQLA's) to support issuance of qualifying collateral, e.g., KT-Notes. Assets are securities, more particularly debt instruments, that are issued or guaranteed by the sovereign, e.g., US Government or by US Government agencies. The KT-Notes issued to investors 11 through Issuers or Co-Issuers, e.g., KS(n) Bermuda and KS(n) Delaware (KS(n) BM and KS(n) DE respectively, as Co-Issuers) or by Karson Finance Master Trust Ireland and by KS(n) Delaware. Thus various issuance structures for the trust can be used. For instance, in Ireland a “Designated Activity Company” incorporated in Ireland can be the legal entity. Also rating can vary such as a P1/AAA (Moody's Investors Service, Inc. New York, N.Y.) rating where P1 is a short term rating and AAA is a long term rating.

Issuance of qualifying collateral, e.g., KT-Notes are exchanged for proceeds “cash” 16 being deposited into a segregated series account (the Reference Series Account or RefSA) or a single account within the trust 12, where the (KT-notes) are managed by a professional portfolio advisor 22 (the Portfolio Advisor) that will acquire the high quality liquid asset (HQLA) portfolio according to a specified set of investment criteria (each, an RefSA Investment Mandate 24). KT-Notes can be redeemed for face amount on an annual basis.

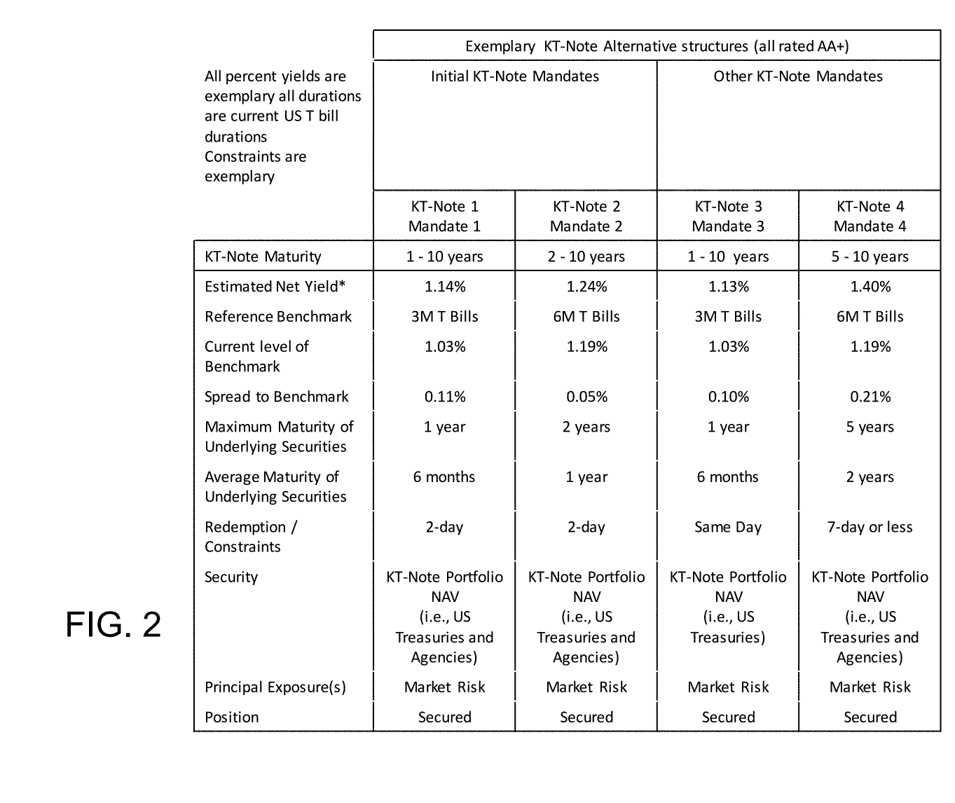

Referring now to FIG. 2, exemplary KT-Note structures (all rated AA+) are shown. KT-Note Maturity can vary from 1-10 years; 2-10 years; 1-10 years and 5-10 years for different mandates KT-notes 1-4 (mandates 1-4) respectively. These various alternative will have varying Estimated Net Yields, use various Reference Benchmarks and have current characteristics for the level of Benchmark, Spread to Benchmark, Maximum Maturity of Underlying Securities, Average Maturity of Underlying Securities, Redemption/Constraints, a Security descriptor and Principal Exposure(s) risks and Position, as shown. All values however are exemplary as the values will vary over time.

For example, in US trading the sovereign is the US Government and the sovereign governmental agency is a US Government agency. The KT-notes have redemption features for settling in 0 or 7 days. (In some instances redemption can be in a range of 0 to 7 days or longer.) Redemption features for the number of days for settling depend on the note type acquired, as discussed below. The maximum number of days for redemption would be market driven.

In one embodiment, KT-Note issuance proceeds are managed in the segregated account 12a (the KT-Note Portfolio) by the professional investment manager (e,g., the Portfolio Advisor 26) according to a specified set of investment criteria 24 to provide attractive performance characteristics, low mark-to-market volatility, capital preservation, and liquidity. These criteria are achieved by maintaining an average KT-Note Portfolio maturity of 3-months and a maximum maturity of 1-year. However, other alternatives are possible.

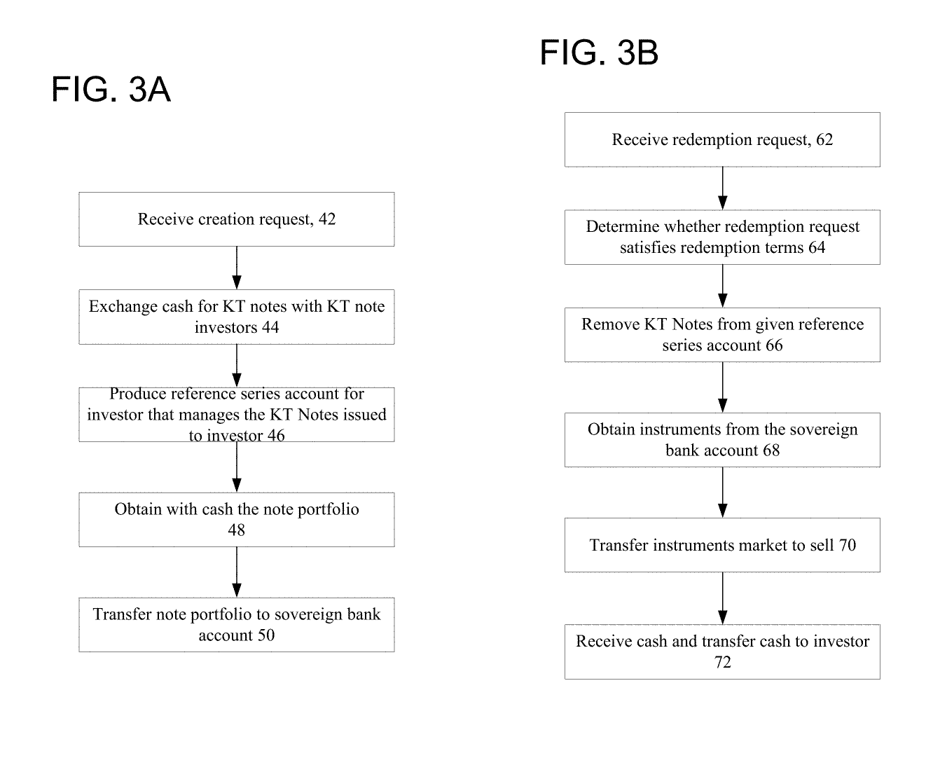

Referring now to FIGS. 3A and 3B, exemplary computer implemented KT-Note creation and redemption processes are shown.

FIG. 3A shows a creation or issuance process 40 that involves receiving 42 a creation request, exchange 44 cash for KT notes with KT note investors. The master trust can produce a reference series account 46 and uses the case to obtain 48 from the market the note portfolio. The note portfolio is transferred 50 to a sovereign bank, e. g. the Federal Reserve that while held at the Federal Reserve is separated on the books and records of the bank (e.g., master trust's custodian), as belonging to the KT-Note. This effectively segregates the securities from those of both the Portfolio Advisor and custodian, thus eliminating counterparty credit risk.

The master trust can produce a reference series account 46 and uses the case to obtain 48 from the market the note portfolio. The note portfolio is transferred 50 to a sovereign bank, e. g. the Federal Reserve that while held at the Federal Reserve is separated on the books and records of the bank (e.g., master trust's custodian), as belonging to the KT-Note. This effectively segregates the securities from those of both the Portfolio Advisor and custodian, thus eliminating counterparty credit risk The assets in the Master Trust 12 that back the KT-Note are the US Treasuries. Since the Master Trust 12 is a series trust, other series could issue notes backed by other assets which are in that designated series of the Master Trust 12.

The KT-Notes can be used for a wide range of market applications, including use as an investment asset, for derivatives collateral, for reinsurance collateral, for funds at insurance markets and for Canadian RSAs (Reinsurance Security Arrangements).

Reinsurance Security Arrangements in Canada are for Insurers/Reinsurers that operate in the domestic Canadian market, and which buy reinsurance covering specified business from affiliated offshore companies that are typically 100%-owned by the parent company, or from unaffiliated reinsurers which are not federally registered. Because the reinsurer is not a registered reinsurance company in Canada, in order for the Reinsurer to obtain reserve credit for the Reinsured Business, the offshore reinsurer must provide collateral under a Reinsurance Security Arrangement (RSA).

FIG. 3B shows a redemption process that involves receiving 62 a creation request, and determining 64 by a computer whether the redemption request is valid, as satisfying redemption terms. When satisfied, the computer will remove 66 KT Notes from a given reference account, obtain a suitable amount of the portfolio from the CSD account at the central bank and transfer securities to sell in the market. The trust 12 receives 72 cash for KT notes and transfers the cash to KT note investor(s) that sent in the redemption request. Exemplary KT-Note criteria:
Description: A senior-secured pass-through note issued (or co-issued) by one (or more) issuer(s) (domestic and/or foreign based legal entities)
Issue size: predetermined
Maturity: 1-10 years (longer terms possible)
Collateral: A managed portfolio of securities issued or guaranteed by a sovereign, e.g., the US Government or by US Government agencies managed by the Portfolio Advisor
Portfolio Advisor: <advisor name>
Rating: <rating>[e.g., AA+]
Listing/Settlement: [XYZ Stock Exchange] with a securities id number, e.g., [ISIN/CUSIP]
Issuance Type: [144A/Reg S] (SEC reg.)
Pro Forma Yield: (varies according to market conditions.)
   where “[144A/Reg S]” refers to Rule 144A of the US Securities Act of 1933, as amended and which provides a safe harbor from registration requirements of the Securities Act of 1933 for certain private resales of minimum $500,000 units of restricted securities to qualified institutional buyers (typically large institutional investors owning at least $100 million in investable assets) and to Reg. S promulgated by the SEC providing a safe harbor from registration for certain securities listed and sold outside the US.

Typically, the potential performance (yield) of the KT notes will compare favorably to performance (yield) of other types of short term debt/savings investments, according to these criteria

| | |
|---|---|
| Credit Quality | KT-Notes are collateralized solely by US Govt. |
| | and US Govt.-guaranteed short-term highly-liquid |
| | debt instruments (i.e., HQLA). |
| Liquidity | KT-Notes may be redeemed at any time. |
| | Unlike prime money market funds (held in share form, |
| | Money Market Funds), KT-Notes are transferrable, and |
| | can be sold or pledged to third parties, allowing investors |
| | access to the deepest global liquidity pools where the |
| | highest bids reside. |
| Counterparty | KT-Notes do not have custodian/Portfolio Advisor |
| risk | counterparty risk. The securities backing a KT-Note issue |
| | are held in a segregated money center bank account (e.g., |
| | BNY Mellon at the central bank (e.g., Federal Reserve), |
| | entered on the books and records of BNY Mellon as |
| | belonging to the KT-Note. An important feature for |
| | regulators. |
| Exit Penalties | KT-Notes have no exit, gating or redemption penalties, |
| | unlike prime Money Market Funds. |
| Capital | KT-Notes are the first High Quality Liquid - Asset |
| Efficiency | Backed Securities. KT-Notes compare favorably with |
| | other ABS in that they attract the same capital charges as |
| | US Treasuries when held as an asset or as collateral. |
| Performance | KT-Notes outperform 3 or 6-month treasuries, |
| | government money market funds and the Overnight Fed |
| | Funds Effective Rate. |

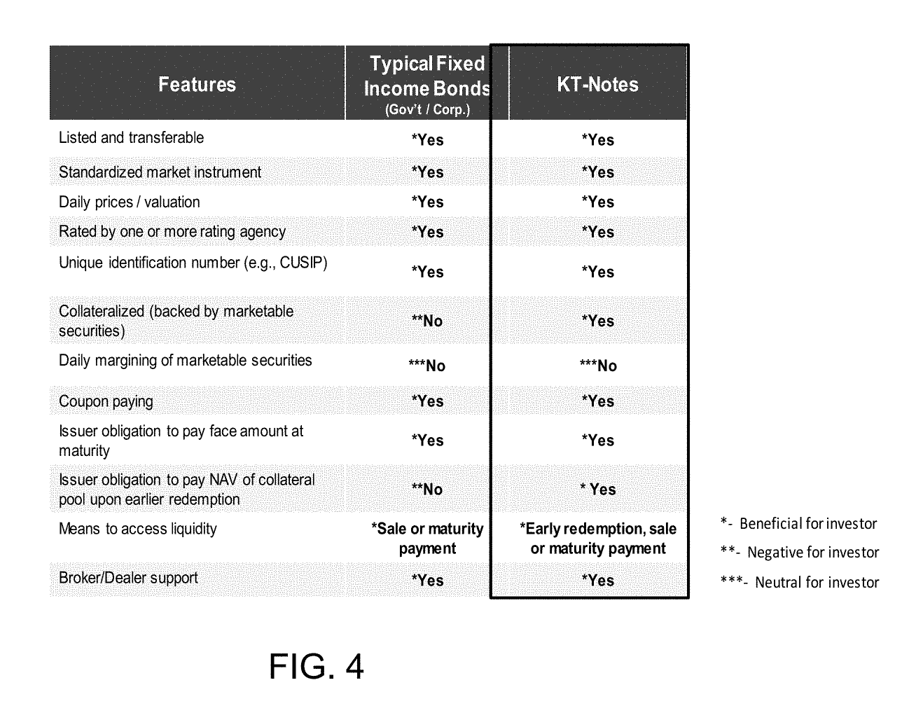

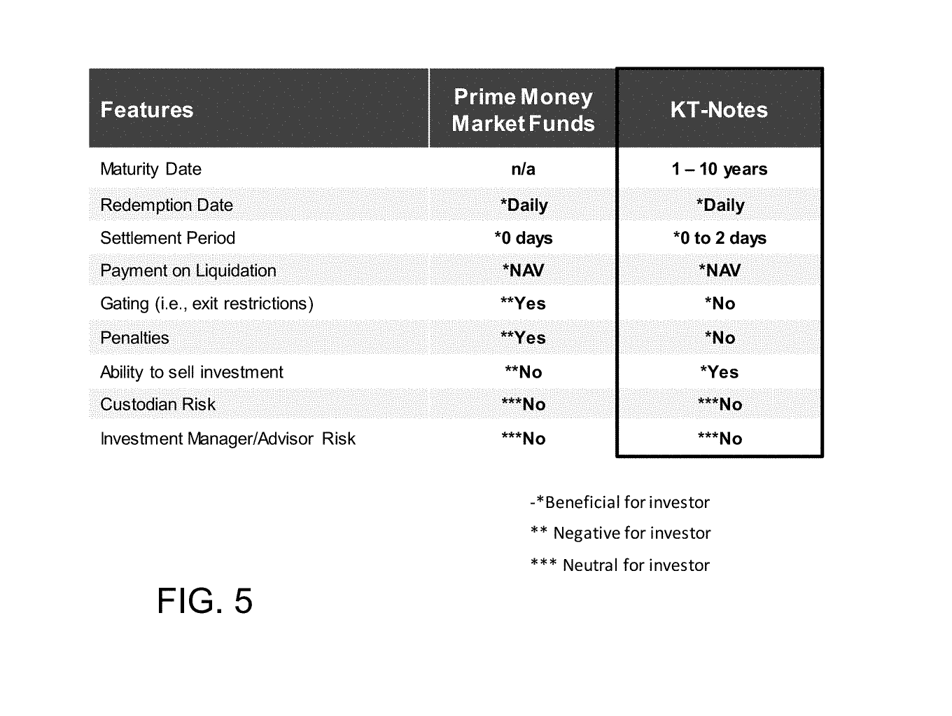

FIGS. 4-5 depict specific advantages of the KT-notes. The investment criteria that supports a KT-Note can be selected by the investor from a range of available RefSA Mandates to match typical desired short-term investment criteria. The holder of a KT-notes owns a security, i.e., a KT-Note, that is rated NAIC* 1 (based on NRSRO** rating of AA+ or its equivalent) instead of money market fund shares. KT-Notes retain NAIC 1 risk-based capital charges. As investment securities, KT-Notes are not subject to the new requirement to value money market funds at fair value with unrealized gains and losses being accounted for accordingly. The KT-Note have no gating or redemption fees, unlike those now associated with money market funds. The KT-Notes avoid depository, custodian and portfolio advisor credit/counterparty risk.

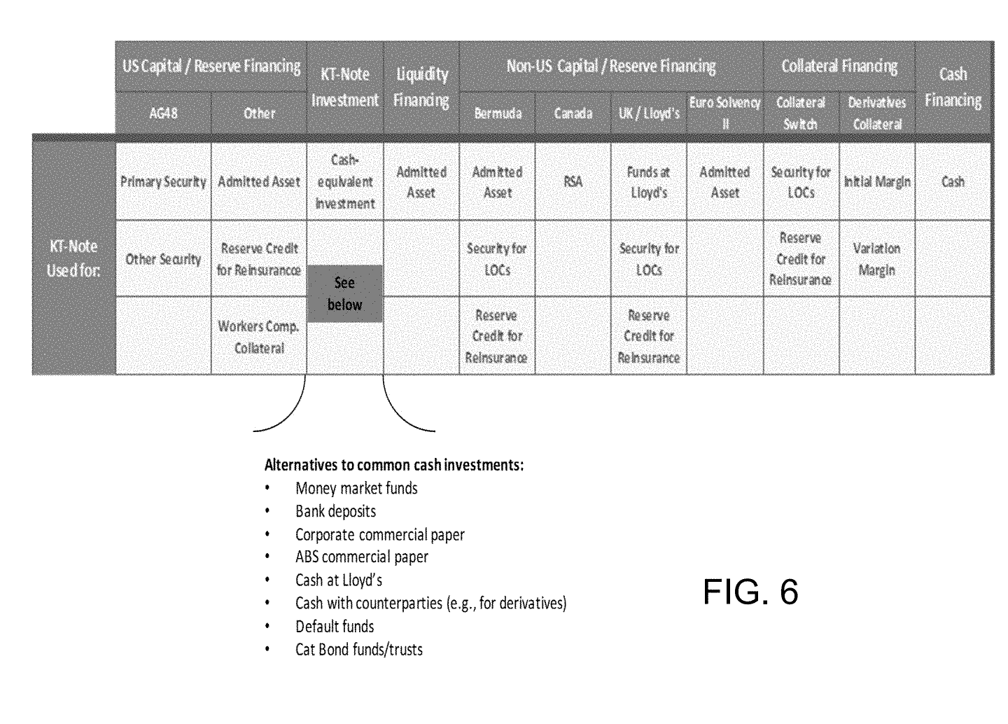

Referring to FIG. 6, in addition to being an investment security, KT-Notes can be used for a range of reserve, capital and collateral management applications. KT-Notes can provide an alternative to these common cash investments:

Money market funds

Bank deposits

Corporate commercial paper

ABS commercial paper

Cash with counterparties (e.g., for derivatives)

Default funds

Cat Bond funds/trusts

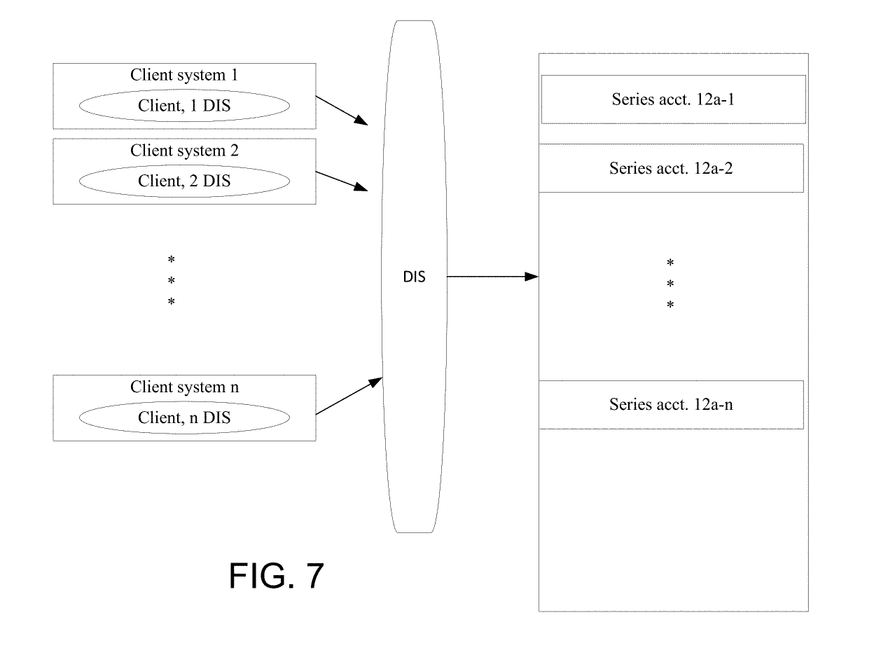

Referring now to FIG. 7, the KT-Note Portfolio held in an RefSA may be viewed electronically using a digital investment service (DIS) such as BNY Mellon's NEXEN system that allows KT-Note holders to view each individual security in the reference KT-Note Portfolio as at the close of business on the prior business day including its value, ratings and market I.D. numbers (ISIN or CUSIP) and produce daily KT-Note Portfolio reports that are automatically emailed to authorized KT-Note holder client systems.

The platform 10 manages a trust that is shown in FIG. 1 as MASTER trust. The trust is managed via a custodian/trustee. In FIG. 1 and in the remaining figures as appropriate, the trust or (trusts) are represented as a storage element in a database 13 (or the like). This representation can be considered as part of the platform 10, in that the intermediary may possess a computer representation of and/or acknowledgement of the existence of the trust in order to facilitate transactions involving the trust through the custodian/trustee 28. The trust includes reference series accounts (RefSA) (not to be confused with Reinsurance Security Arrangement (RSA) or RSA encryption).

The trust 26 holds the assets to support issuance of the qualifying collateral, e.g., KT-notes. The assets are instruments issued or guaranteed by the US Government or by US Government agencies. The KT-Notes are issued to investors through issuers or co-issuers as mentioned above, with the proceeds being deposited into a segregated series account (the Reference Series Account or RefSA) or a single account within the trust where the securities are managed by a professional portfolio advisor (the Portfolio Advisor) that will acquire a high quality liquid asset (HQLA) portfolio according to a specified set of investment criteria (each, an RefSA Mandate).

As used herein HQLA is defined in reference to the Basel Committee on Banking Supervision Basel III: The Liquidity Coverage Ratio and liquidity risk monitoring tools (dated January 2013) and any then current modifications thereto.

The KT-Note Portfolio is held in an account maintained by a custodian entity, e.g., a New York based custody bank, but held at the Federal Reserve and entered on the books and records of the New York based custody bank as belonging to the KT-Note. This mechanism segregates the underlying securities from the Investment Advisor and the bank's other assets and eliminates counterparty credit risk. The KT-Notes pay a periodic net pass-through variable coupon and their full face amount of principal at maturity, but may be redeemed in whole or in part at any time. If redeemed early, the KT-Notes will pay cash in an amount equal to the RefSA's NAV.

An RefSA's NAV (net asset value) can be determined according to (aggregate of current value of securities in the segregated series account minus fees, expenses, plus accrued interest)/number of notes outstanding.

The KT-Notes are rated [e.g., AA+ rated or P1/AAA etc., (by a Nationally recognized statistical rating organization (NRSRO) investment securities that are listed on a stock exchange, e.g., the Irish Stock Exchange in Dublin IR and settled into and cleared by a clearing entity, e.g., the Depository Trust & Clearing Corporation (DTCC) under a unique market identification number (e.g., an ISIN or CUSIP) number. The KT-Notes are transferable and are backed by the segregated account holdings of the KT-Note Portfolio (i.e., HQLAs) and are redeemable in whole or in part for settlement same day, or in a specified number of days (e.g., 2 days).

The KT-Notes can generate liquidity in a number of ways. The KT-Notes can be sold in the [144A/Reg. S] markets for cash settlement, can be redeemed with the issuer for cash settlement in 7 days or less at any time prior to their final maturity date, at the holder's option and can be financed in the tri-party repo market. The KT-Notes are redeemed automatically in a cash settlement on their final maturity dates (e.g., a date in 1-10 years from their issuance date).

| | KT-Note | KT-Note |
|---|---|---|
| Investment Criteria | Mandate 1 | Mandate 2 |
| US Government obligations (Notes and Bills) | Yes | Yes |
| US Government Agencies obligations | Yes | Yes |
| Obligations that are fully insured or | Yes | Yes |
| guaranteed by the US Government | | |
| Obligations that are fully insured or | Yes | Yes |
| guaranteed by an Agency of the US Government | | |
| Maximum Maturity of holdings | 1 year | 2 years |
| Average Maturity/Duration of holdings | 6 months | 1 year |

### Other Mandates are Possible

Use Case

The techniques discussed herein provide simplified uses of the KT-Notes for various purposes. As mentioned, the KT-Notes can be used for a wide range of market applications, including use as an investment asset, for derivatives collateral, for reinsurance collateral, for funds at insurance markets such as Lloyds and for Canadian RSAs (Reinsurance Security Arrangements).

For example in the context of re-insurance collateral, a company needing collateral for re-insurance purposes can simply be transferred the KT-Notes that would then be used for collateral. For instance, a large insurance holding company is subject to US insurance regulations regarding capital reserves. This large insurance holding company can have one or more captive insurance companies that are not subject to the same level of capital reserves regulation (e.g., none or reduced capital reserves), but which has a re-insurance relationship to the large insurance holding company. In this case, the large insurance holding company buys the KT-notes and transfers the KT-notes in appropriate amounts to the one or more captive insurance companies. The one or more captive insurance companies can use the notes as collateral for the reinsurance obligations.

In the event of a default by the one of the captive insurance companies, the large insurance holding company takes back the KT-notes from the defaulting one of the insurance companies, and either sells the KT-notes on the market or redeems the KT-notes with the trust for cash to satisfy any reinsurance claims against the defaulting one of the captive insurance companies.

One or more parts of the platforms are machine-based, e.g., established on processors. The processes involving the platforms such as establishing the trusts, collecting eligible securities, creating series accounts for the clients, and others can include computer programs stored and executed by a machine. The platform can be accessible through a network, e.g., the Internet.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

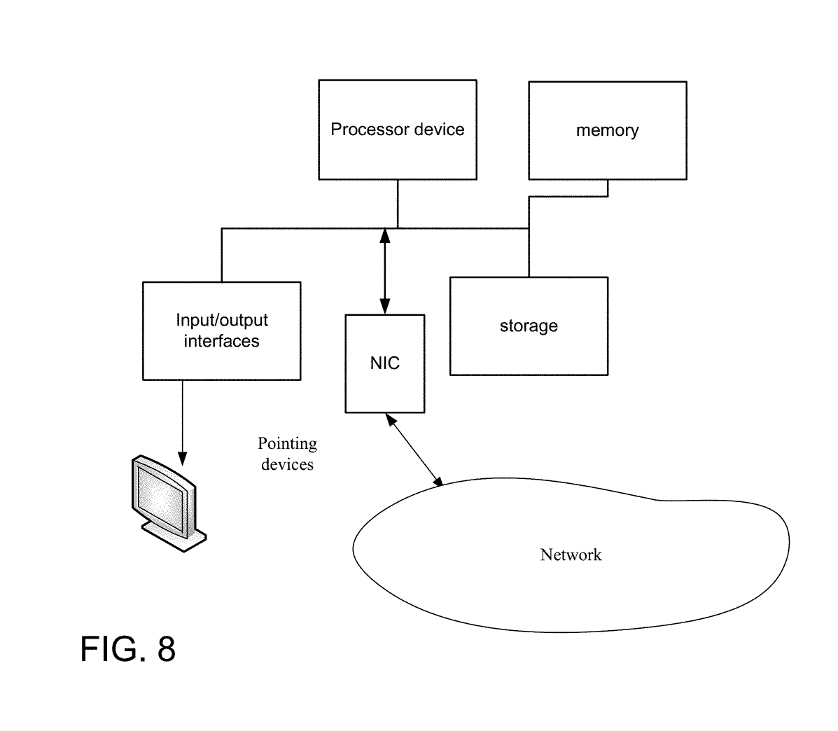

FIG. 8 is a schematic diagram of an example computer system. The system can be used for practicing operations of the platform described above. For example, one or more parts of the platform can reside and be executed on the computer system. The system can include a processor device, a memory, a storage device, and input/output interfaces interconnected via a bus. The processor is capable of processing instructions within the system. These instructions can implement one or more aspects of the systems, components and techniques described above. In some implementations, the processor is a single-threaded processor. In other implementations, the processor is a multi-threaded processor. The processor can include multiple processing cores and is capable of processing instructions stored in the memory or on the storage device to display graphical information for a user interface on output monitor device.

The computer system can be connected to a network, e.g., the Internet, through a network interface controller. Other systems, such as the client systems, the counterparty systems, the bank systems, etc. discussed above can also be connected to the same network or a different network that can communicate with the network.

The memory is a computer readable medium such as volatile or non-volatile that stores information within the system. The memory can store processes related to the functionality of the valuation system or valuation platform, for example. The storage device is capable of providing persistent storage for the system. The storage device can include a floppy disk device, a hard disk device, an optical disk device, or a tape device, or other suitable persistent storage mediums. The storage device can store the various databases described above. The input/output device provides input/output operations for the system. The input/output device can include a keyboard, a pointing device, and a display unit for displaying graphical user interfaces.

An exemplary view of a computer system is shown in FIG. 8, and is but one example. In general, embodiments of the subject matter and the functional operations described in this specification can be implemented in digital electronic circuitry, or in computer software, firmware, or hardware. Embodiments of the subject matter described in this specification can be implemented as one or more computer program products, i.e., one or more modules of computer program instructions encoded on a computer readable medium for execution by, or to control the operation of, data processing apparatus. The computer readable medium is a machine-readable storage device. The invention can be embodied in and/or or used with various apparatus, devices, and machines for processing data, including by way of example a programmable processor, a computer, or multiple processors or computers.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment.

Embodiments of the invention can be implemented in a computing system that includes a back end component, e.g., as a data server, or that includes a middleware component, e.g., an application server, or that includes a front end component, e.g., a client computer having a graphical user interface or a web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

What is claimed is:

1. A computer-implemented method comprising:
recording, by one or more computers, receipt of proceeds obtained from a first party and placed in a first reference series account in a legal trust for the first party;
acquiring a high quality liquid asset portfolio according to a specified set of investment criteria for deposit in the first reference series account;
transferring the high quality liquid asset portfolio to a segregated money center bank account at a sovereign central bank that are entered on the books and records of money center bank as backing a high-quality, redeemable security; and
issuing the high-quality, redeemable security to the investor backed by the acquired high quality liquid asset portfolio.

2. The method of claim 1 wherein the high quality liquid asset portfolio are instruments issued or guaranteed by a sovereign or sovereign governmental agency;

3. The method of claim 1 wherein the high quality liquid asset portfolio are instruments issued or guaranteed by the US Government or the US Governmental agency.

4. The method of claim 1 wherein the redeemable securities have plural types and redemption features include a feature for settling in 0 or 2 days depending on the redeemable securities type acquired.

5. The method of claim 1 wherein the redeemable securities can be used as an investment asset, derivative collateral, reinsurance collateral, funds at insurance markets and for Canadian Reinsurance Security Arrangements.

6. The method of claim 1 wherein the redeemable securities are listed on a securities exchange or securities market having a unique market identification number.

7. The method of claim 1 wherein the high quality liquid asset portfolio are debt instruments of a sovereign government.

8. The method of claim 1 further comprising:
recording, by the one or more computers, receipt of proceeds obtained from additional parties and placed corresponding additional reference series accounts in the legal trust for the additional parties;
acquiring additional high quality liquid asset portfolios according to specified sets of investment criteria for deposit in the additional reference series accounts; and
issuing additional high-quality, redeemable securities backed by the acquired high quality liquid asset portfolios deposited in the additional reference series accounts.

9. A computer-implemented method comprising:
recording, by one or more computers, receipt of proceeds obtained from a first party and placed in a first reference series account in a legal trust for the first party;
acquiring by a first entity a high quality liquid asset portfolio according to a specified set of investment criteria for deposit in the first reference series account; and
issuing high-quality, redeemable securities backed by the acquired high quality liquid asset portfolio to the first entity;
receiving by a second, related entity the high-quality, redeemable securities with the second, related entity seeking collateral for re-insurance; and
using by the second, related entity, the high-quality, redeemable securities for collateral.

10. The method of claim 9 wherein the first entity is a large insurance holding company subject to sovereign insurance regulations regarding capital reserves.

11. The method of claim 9 wherein the second entity is a captive insurance company of the large insurance holding company, which captive insurance company is not subject to the same level of capital reserves regulation, as the large insurance holding company, but which has a re-insurance relationship to the large insurance holding company.

12. The method of claim 9 wherein the level of capital reserves of the second entity is none or reduced capital reserves compared to the first entity.

13. A system comprises:
by one or more computers systems comprising a processor and memory operatively coupled and a computer readable storage medium storing computer-executable instructions to cause the one or more computer systems to:
receive proceeds obtained from a first party and placed in a first reference series account in a legal trust for the first party;
acquire a high quality liquid asset portfolio according to a specified set of investment criteria for deposit in the first reference series account;
transfer the high quality liquid asset portfolio to a segregated money center bank account at a sovereign central bank that are entered on the books and records of money center bank as backing a high-quality, redeemable security; and
issue the high-quality, redeemable security to the investor backed by the acquired high quality liquid asset portfolio.

14. The system of claim 13 wherein the high quality liquid asset portfolio are instruments issued or guaranteed by a sovereign or sovereign governmental agency;

15. The system of claim 13 wherein the redeemable securities can be used as an investment asset, derivative collateral, reinsurance collateral, funds at insurance markets and for Canadian Reinsurance Security Arrangements.

16. The system of claim 13 wherein the redeemable securities are listed on a securities exchange or securities market having a unique market identification number.

17. The system of claim 13 wherein the high quality liquid asset portfolio are debt instruments of a sovereign government.

18. The system of claim 13 further configured to:
record receipt of proceeds obtained from additional parties and placed corresponding additional reference series accounts in the legal trust for the additional parties;
acquire additional high quality liquid asset portfolios according to specified sets of investment criteria for deposit in the additional reference series accounts; and
issue additional high-quality, redeemable securities backed by the acquired high quality liquid asset portfolios deposited in the additional reference series accounts.
